(19) United States
(12) Patent Application Publication
(10) Pub. No.: US 2012/0204050 A1
(43) Pub. Date: Aug. 9, 2012

(54) MANAGEMENT APPARATUS AND PROGRAM

(75) Inventors: Hidekazu Miyoshi, Osaka-shi (JP); Takeshi Ozaki, Osaka-shi (JP); Takashi Yano, Shinagawa-ku (JP)

(73) Assignee: SUMITOMO ELECTRIC INDUSTRIES, LTD., Osaka-shi (JP)

(21) Appl. No.: 13/502,620

(22) PCT Filed: Dec. 8, 2010
(86) PCT No.: PCT/JP10/72025

§ 371 Date: Apr. 18, 2012

(30) Foreign Application Priority Data
Dec. 14, 2009 (JP) 2009-283239
Dec. 14, 2009 (JP) 2009-283240
Dec. 14, 2009 (JP) 2009-283241

(51) Int. Cl. G06F 1/32; G06F 1/26

(52) U.S. Cl. 713/323

(57) ABSTRACT

Power consumption of a communication apparatus having a plurality of operating modes can be accurately determined. A management apparatus 4 manages a communication apparatus 3 having a plurality of operating modes, and includes an obtaining unit 421 that obtains information about power consumption of the communication apparatus 3; a mode identifying unit 422 that identifies an operating mode of the communication apparatus 3; and a power managing unit 424 that determines power consumption in each operating mode of the communication apparatus 3 by associating information about power consumption (signals S21) obtained by the obtaining unit 421 with operating modes (signals S23) identified by the mode identifying unit 422.

### TECHNICAL FIELD

The present invention relates to a management apparatus and a program that manage a communication apparatus having a plurality of operating modes.

### BACKGROUND ART

Due to increased environmental awareness in recent years, a demand for a further reduction in power consumption has been getting stronger even for communication apparatuses such as personal computers.

The following Patent Literature 1 discloses a network system that attempts to improve the power saving efficiency of printers. In the network system, printers having a startup control unit, client devices, and a power saving management apparatus are connected to one another via a network. When a printer does not receive a print request from the client devices continuously over a predetermined period of time, the printer stops feeding to its main body unit other than the startup control unit and transitions to a power saving mode, and broadcasts a power saving transition notification indicating the transition to the network. The power saving management apparatus receives the power saving transition notification and thereby records information indicating that the printer has transitioned to the power saving mode. Thereafter, when a print request is sent to the printer from a client device, the power saving management apparatus detects the print request flowing through the network and sends a startup request notification to the printer. The startup control unit receives the startup request notification and thereby resumes feeding to the main body unit. By this, the printer goes into a printable state.

### CITATION LIST

### Patent Literature

Patent Literature 1: Japanese Unexamined Patent Publication No. 2001-75687

SUMMARY OF INVENTION

### Technical Problem

According to the network system disclosed in the above-described Patent Literature 1, the power consumption of a printer can be reduced by the printer transitioning to a power saving mode. However, since measurement of the power consumption of the printer is not performed, a user cannot realize how much power saving effect is actually obtained. To increase user's environmental awareness, it is very effective to measure the power consumption of a communication apparatus and provide the user with information about the power consumption. However, in a communication apparatus having a plurality of operating modes, since power consumption may significantly vary depending on the operating mode, to accurately grasp the power consumption of the communication apparatus, there is a need to determine power consumption in each operating mode.

The present invention has been made in view of such circumstances, and an object thereof is to obtain a management apparatus and a program that are capable of accurately determining the power consumption of a communication apparatus having a plurality of operating modes (first object).

In addition, according to the network system disclosed in the above-described Patent Literature 1, the power consumption of a printer can be reduced by the printer transitioning to the power saving mode. Here, to achieve further power saving, it is effective to perform power control to stop feeding to the printer when a power saving mode state continues for a long period of time. However, in power control for a communication apparatus having a plurality of operating modes, when power control that is not suitable for the current operating mode is performed, there is a possibility of causing significant trouble to the communication apparatus. For example, for a personal computer in the power saving mode, if feeding to the personal computer is suddenly stopped, then there is a possibility of causing events such as loss of data stored in a memory and hard disk trouble.

The present invention has been made in view of such circumstances, and an object thereof is to obtain a management apparatus and a program that are capable of performing optimum power control on a communication apparatus having a plurality of operating modes, according to each operating mode while avoiding the occurrence of trouble (second object).

In addition, according to the network system disclosed in the above-described Patent Literature 1, when a printer transitions to the power saving mode, the printer broadcasts a power saving transition notification to the network. Therefore, an existing printer that does not have the function of sending a power saving transition notification cannot be used, and when an existing printer is to be used, there is a need to additionally provide the printer with the function of sending a power saving transition notification. In addition, with the broadcast of a power saving transition notification, the amount of traffic on the network increases.

The present invention has been made in view of such circumstances, and an object thereof is to obtain a management apparatus and a program that do not need to provide a communication apparatus with an operating mode notification function and that are capable of avoiding an increase in the amount of traffic caused by the notification of an operating mode (third object).

### Solution to Problem

(1-1) To achieve the first object, a first aspect of the present invention provides a management apparatus that manages a communication apparatus having a plurality of operating modes, the management apparatus including: obtaining device for obtaining information about power consumption of the communication apparatus; mode identifying device for identifying an operating mode of the communication apparatus; and managing device for determining power consumption in each operating mode of the communication apparatus by associating information about power consumption obtained by the obtaining device with operating modes identified by the mode identifying device.

According to the management apparatus of the first aspect, the obtaining device obtains information about power consumption of the communication apparatus, and the mode identifying device identifies an operating mode of the communication apparatus. Then, the managing device determines power consumption in each operating mode of the communication apparatus by associating information about power consumption obtained by the obtaining device with operating modes identified by the mode identifying device. By thus determining power consumption in each operating mode of the communication apparatus, the power consumption of the communication apparatus having a plurality of operating modes can be accurately determined.

(1-2) A second aspect of the present invention provides the management apparatus according to the first aspect, further comprising output device for outputting information about the power consumption in each operating mode of the communication apparatus determined by the managing device.

According to the management apparatus of the second aspect, the output device outputs information about the power consumption in each operating mode of the communication apparatus determined by the managing device. By outputting the information, the information can be utilized by a user, etc.

In the management apparatus according to the second aspect, the output device desirably has display device for displaying information about power consumption in each operating mode of the communication apparatus.

The display device displays information about power consumption in each operating mode of the communication apparatus. Therefore, the information can be provided to the user, and as a result, the user realizes the power saving effect, enabling to increase user's environmental awareness. In addition, when, for example, buying a new communication apparatus, the user can compare accurate power consumption between communication apparatuses. Thus, by removing a communication apparatus with high power consumption and introducing a new communication apparatus of power saving type, it can help build an environmentally friendly network system.

In addition, in the management apparatus according to the second aspect, the output device desirably has sending device for sending information about power consumption in each operating mode of the communication apparatus.

The sending device sends information about power consumption in each operating mode of the communication apparatus. Therefore, by sending the information to a contract service company such as a provider and accumulating and analyzing the information by the service company, service such as giving advice on a further reduction in power consumption can be provided to the user.

(1-3) A third aspect of the present invention provides the management apparatus according to the first or second aspect, further comprising detecting device for detecting communication packets sent and received to/from the communication apparatus, from a communication network, wherein the mode identifying device identifies the operating mode of the communication apparatus based on the information about the power consumption obtained by the obtaining device and information about the communication packets detected by the detecting device.

According to the management apparatus of the third aspect, the detecting device detects communication packets sent and received to/from the communication apparatus, from the communication network and the mode identifying device identifies an operating mode of the communication apparatus based on the information about power consumption obtained by the obtaining device and information about the communication packets detected by the detecting device. By the management apparatus thus identifying itself an operating mode of the communication apparatus by the mode identifying device, a notification of the operating mode from the communication apparatus to the management apparatus becomes unnecessary. As a result, it becomes unnecessary to provide the communication apparatus with an operating mode notification function and an increase in the amount of traffic caused by the notification of an operating mode can be avoided.

(1-4) A fourth aspect of the present invention provides the management apparatus according to the first or second aspect, wherein the mode identifying device identifies the operating mode of the communication apparatus by obtaining information indicating the operating mode of the communication apparatus from the communication apparatus.

According to the management apparatus of the fourth aspect, the mode identifying device identifies an operating mode of the communication apparatus by obtaining information indicating the operating mode of the communication apparatus from the communication apparatus. By the communication apparatus notifying the management apparatus of information indicating its operating mode, the mode identifying unit can accurately identify the operating mode of the communication apparatus.

(1-5) A fifth aspect of the present invention provides a program causing a computer mounted on a management apparatus that manages a communication apparatus having a plurality of operating modes, to function as: obtaining device for obtaining information about power consumption of the communication apparatus; mode identifying device for identifying an operating mode of the communication apparatus; and managing device for determining power consumption in each operating mode of the communication apparatus by associating information about power consumption obtained by the obtaining device with operating modes identified by the mode identifying device.

According to the program of the fifth aspect, the obtaining device obtains information about power consumption of the communication apparatus, and the mode identifying device identifies an operating mode of the communication apparatus. Then, the managing device determines power consumption in each operating mode of the communication apparatus by associating information about power consumption obtained by the obtaining device with operating modes identified by the mode identifying device. By thus determining power consumption in each operating mode of the communication apparatus, the power consumption of the communication apparatus having a plurality of operating modes can be accurately determined.

(2-1) To achieve the second object, a sixth aspect of the present invention provides a management apparatus that manages a communication apparatus having a plurality of operating modes, the management apparatus including: mode identifying device for identifying an operating mode of the communication apparatus; and control device for performing power control of the communication apparatus, wherein the control device performs power control in a manner according to each operating mode identified by the mode identifying device.

According to the management apparatus of the sixth aspect, the mode identifying device identifies an operating mode of the communication apparatus, and the control device performs power control in a manner according to each operating mode identified by the mode identifying device. By the control device thus performing power control in a manner according to each operating mode, optimum power control can be performed according to each operating mode while avoiding the occurrence of trouble caused by performing power control that is not suitable for the operating mode.

(2-2) A seventh aspect of the present invention provides the management apparatus according to the sixth aspect, wherein the plurality of operating modes include a standby mode in which power to the communication apparatus is in an on state and sending and receiving of communication packets to/from the communication apparatus are not being performed, and the control device performs power control to shut down the communication apparatus when a predetermined condition is satisfied in a state in which the mode identifying device identifies the operating mode of the communication apparatus as the standby mode.

According to the management apparatus of the seventh aspect, the control device performs power control to shut down the communication apparatus when a predetermined condition is satisfied in a state in which the mode identifying device identifies the operating mode of the communication apparatus as a standby mode. Since power is consumed even in the standby mode, by performing power control to shut down the communication apparatus, the power consumption of the communication apparatus can be reduced over the case in which the standby mode stays on.

(2-3) An eighth aspect of the present invention provides the management apparatus according to the seventh aspect, further comprising detecting device for detecting communication packets sent and received to/from the communication apparatus, from a communication network, wherein the predetermined condition is that, in a state in which the mode identifying device identifies the operating mode of the communication apparatus as the standby mode, the detecting device has not detected a predetermined number or more of communication packets sent and received to/from the communication apparatus, in a last predetermined period.

According to the management apparatus of the eighth aspect, power control to shut down the communication apparatus is performed on condition that, in a state in which the mode identifying device identifies the operating mode of the communication apparatus as the standby mode, the detecting device has not detected a predetermined number or more of communication packets sent and received to/from the communication apparatus, in a last predetermined period. In a situation in which there is a low likelihood of a transition from the standby mode to an active mode such as the above, by performing power control to shut down the communication apparatus rather than allowing the standby mode to stay on, the power consumption of the communication apparatus can be reduced.

(2-4) A ninth aspect of the present invention provides the management apparatus according to the sixth aspect, wherein the plurality of operating modes include a power saving mode in which power to the communication apparatus is in an on state and some functions of the communication apparatus are not operating, and the control device performs power control to shut down the communication apparatus when a predetermined condition is satisfied in a state in which the mode identifying device identifies the operating mode of the communication apparatus as the power saving mode.

According to the management apparatus of the ninth aspect, the control device performs power control to shut down the communication apparatus when a predetermined condition is satisfied in a state in which the mode identifying device identifies the operating mode of the communication apparatus as a power saving mode. Since power is consumed even in the power saving mode, by performing power control to shut down the communication apparatus, the power consumption of the communication apparatus can be reduced over the case in which the power saving mode stays on.

(2-5) A tenth aspect of the present invention provides the management apparatus according to the ninth aspect, wherein the predetermined condition is that, in a state in which the mode identifying device identifies the operating mode of the communication apparatus as the power saving mode, the state continues over a predetermined period of time.

According to the management apparatus of the tenth aspect, power control to shut down the communication apparatus is performed on condition that, in a state in which the mode identifying device identifies the operating mode of the communication apparatus as the power saving mode, the state continues over a predetermined period of time. In a situation in which there is a low likelihood of a transition from the power saving mode to the active mode such as the above, by performing power control to shut down the communication apparatus rather than allowing the power saving mode to stay on, the power consumption of the communication apparatus can be reduced.

(2-6) An eleventh aspect of the present invention provides the management apparatus according to any one of the seventh to tenth aspects, wherein the control device further performs power control to stop feeding to the communication apparatus, in addition to the power control to shut down the communication apparatus.

According to the management apparatus of the eleventh aspect, the control device performs power control to stop feeding to the communication apparatus, in addition to the power control to shut down the communication apparatus. By stopping feeding to the communication apparatus, the power consumption of the communication apparatus can be further reduced.

(2-7) A twelfth aspect of the present invention provides the management apparatus according to any one of the sixth to eleventh aspects, further including: obtaining device for obtaining information about power consumption of the communication apparatus; and detecting device for detecting communication packets sent and received to/from the communication apparatus, from a communication network, wherein the mode identifying device identifies the operating mode of the communication apparatus based on the information about the power consumption obtained by the obtaining device and information about the communication packets detected by the detecting device.

According to the management apparatus of the twelfth aspect, the obtaining device obtains information about power consumption of the communication apparatus, and the detecting device detects communication packets sent and received to/from the communication apparatus, from the communication network. Then, the mode identifying device identifies an operating mode of the communication apparatus based on the information about power consumption obtained by the obtaining device and information about the communication packets detected by the detecting device. By the management apparatus thus identifying itself an operating mode of the communication apparatus by the mode identifying device, a notification of the operating mode from the communication apparatus to the management apparatus becomes unnecessary. As a result, it becomes unnecessary to provide the communication apparatus with an operating mode notification function and an increase in the amount of traffic caused by the notification of an operating mode can be avoided.

(2-8) A thirteenth aspect of the present invention provides the management apparatus according to any one of the sixth to eleventh aspects, wherein the mode identifying device identifies the operating mode of the communication apparatus by obtaining information indicating the operating mode of the communication apparatus from the communication apparatus.

According to the management apparatus of the thirteenth aspect, the mode identifying device identifies an operating mode of the communication apparatus by obtaining information indicating the operating mode of the communication apparatus from the communication apparatus. By the communication apparatus notifying the management apparatus of information indicating its operating mode, the mode identifying unit can accurately identify the operating mode of the communication apparatus.

(2-9) A fourteenth aspect of the present invention provides a program causing a computer mounted on a management apparatus that manages a communication apparatus having a plurality of operating modes, to function as: mode identifying device for identifying an operating mode of the communication apparatus; and control device for performing power control of the communication apparatus, wherein the control device performs power control in a manner according to each operating mode identified by the mode identifying device.

According to the program of the fourteenth aspect, the mode identifying device identifies an operating mode of the communication apparatus, and the control device performs power control in a manner according to each operating mode identified by the mode identifying device. By the control device thus performing power control in a manner according to each operating mode, optimum power control can be performed according to each operating mode while avoiding the occurrence of trouble caused by performing power control that is not suitable for the operating mode.

(3-1) To achieve the third object, a fifteenth aspect of the present invention provides a management apparatus that manages a communication apparatus having a plurality of operating modes, the management apparatus including: obtaining device for obtaining information about power consumption of the communication apparatus; detecting device for detecting communication packets sent and received to/from the communication apparatus, from a communication network; and mode identifying device for identifying an operating mode of the communication apparatus based on the information about the power consumption obtained by the obtaining device and information about the communication packets detected by the detecting device.

According to the management apparatus of the fifteenth aspect, the obtaining device obtains information about power consumption of the communication apparatus, and the detecting device detects communication packets sent and received to/from the communication apparatus, from the communication network. Then, the mode identifying device identifies an operating mode of the communication apparatus based on the information about power consumption obtained by the obtaining device and information about the communication packets detected by the detecting device. By the management apparatus thus identifying itself an operating mode of the communication apparatus by the mode identifying device, a notification of the operating mode from the communication apparatus to the management apparatus becomes unnecessary. As a result, it becomes unnecessary to provide the communication apparatus with an operating mode notification function and an increase in the amount of traffic caused by the notification of an operating mode can be avoided.

(3-2) A sixteenth aspect of the present invention provides the management apparatus according to the fifteenth aspect, wherein the plurality of operating modes include an active mode in which power to the communication apparatus is in an on state and sending and receiving of communication packets to/from the communication apparatus are being performed, and the mode identifying device identifies the operating mode of the communication apparatus as the active mode by a fact that the power consumption of the communication apparatus obtained by the obtaining device is greater than or equal to a predetermined threshold value and the detecting device has detected a predetermined number or more of communication packets sent and received to/from the communication apparatus, in a last predetermined period.

According to the management apparatus of the sixteenth aspect, the mode identifying device identifies the operating mode of the communication apparatus as the active mode by a fact that the power consumption of the communication apparatus obtained by the obtaining device is greater than or equal to a predetermined threshold value and the detecting device has detected a predetermined number or more of communication packets sent and received to/from the communication apparatus, in a last predetermined period. Therefore, the fact that the operating mode of the communication apparatus is the active mode can be accurately identified by the mode identifying device.

(3-3) A seventeenth aspect of the present invention provides the management apparatus according to the fifteenth aspect, wherein the plurality of operating modes include a standby mode in which power to the communication apparatus is in an on state and sending and receiving of communication packets to/from the communication apparatus are not being performed, and the mode identifying device identifies the operating mode of the communication apparatus as the standby mode by a fact that the power consumption of the communication apparatus obtained by the obtaining device is greater than or equal to a predetermined threshold value and the detecting device has not detected a predetermined number or more of communication packets sent and received to/from the communication apparatus, in a last predetermined period.

According to the management apparatus of the seventeenth aspect, the mode identifying device identifies the operating mode of the communication apparatus as the standby mode by a fact that the power consumption of the communication apparatus obtained by the obtaining device is greater than or equal to a predetermined threshold value and the detecting device has not detected a predetermined number or more of communication packets sent and received to/from the communication apparatus, in a last predetermined period. Therefore, the fact that the operating mode of the communication apparatus is the standby mode can be accurately identified by the mode identifying device.

(3-4) An eighteenth aspect of the present invention provides the management apparatus according to the fifteenth aspect, wherein the plurality of operating modes include an inactive mode in which power to the communication apparatus is in a off state, and the mode identifying device identifies the operating mode of the communication apparatus as the inactive mode when satisfying neither of: first conditions that the power consumption of the communication apparatus obtained by the obtaining device is greater than or equal to a predetermined threshold value and the detecting device has detected a predetermined number or more of communication packets sent and received to/from the communication apparatus, in a last predetermined period; and second conditions that the power consumption of the communication apparatus obtained by the obtaining device is greater than or equal to the threshold value and the detecting device has not detected a predetermined number or more of communication packets sent and received to/from the communication apparatus, in a last predetermined period.

According to the management apparatus of the eighteenth aspect, the mode identifying device identifies the operating mode of the communication apparatus as an inactive mode when neither of the first conditions and the second conditions is satisfied. Therefore, the fact that the operating mode of the communication apparatus is the inactive mode can be identified by the mode identifying device.

(3-5) A nineteenth aspect of the present invention provides the management apparatus according to the sixteenth aspect, the plurality of operating modes further include an inactive mode in which the power to the communication apparatus is in a off state, and the mode identifying device identifies the operating mode of the communication apparatus as the inactive mode by a fact that, in a state in which the operating mode of the communication apparatus is identified as the active mode, the power consumption of the communication apparatus obtained by the obtaining device is less than the threshold value and the detecting device has detected a predetermined communication packet indicating that the communication apparatus leaves the communication network, the communication network being a source.

According to the management apparatus of the nineteenth aspect, the mode identifying device identifies the operating mode of the communication apparatus as the inactive mode by a fact that, in a state in which the operating mode of the communication apparatus is identified as the active mode, the power consumption of the communication apparatus obtained by the obtaining device is less than the threshold value and the detecting device has detected a predetermined communication packet indicating that the communication apparatus leaves the communication network which is the source. Therefore, the fact that the operating mode of the communication apparatus has transitioned from the active mode to the inactive mode can be accurately identified by the mode identifying device.

(3-6) A twentieth aspect of the present invention provides the management apparatus according to the eighteenth or nineteenth aspect, wherein the plurality of operating modes include an active mode in which the power to the communication apparatus is in an on state and sending and receiving of communication packets to/from the communication apparatus are being performed, and the mode identifying device identifies the operating mode of the communication apparatus as the active mode by a fact that, in a state in which the operating mode of the communication apparatus is identified as the inactive mode, the power consumption of the communication apparatus obtained by the obtaining device is greater than or equal to the threshold value.

According to the management apparatus of the twentieth aspect, the mode identifying device identifies the operating mode of the communication apparatus as the active mode by a fact that, in a state in which the operating mode of the communication apparatus is identified as the inactive mode, the power consumption of the communication apparatus obtained by the obtaining device is greater than or equal to the threshold value. Therefore, the fact that the operating mode of the communication apparatus has transitioned from the inactive mode to the active mode can be accurately identified by the mode identifying device.

(3-7) A twenty-first aspect of the present invention provides the management apparatus according to the eighteenth or nineteenth aspect, wherein the plurality of operating modes include an active mode in which the power to the communication apparatus is in an on state and sending and receiving of communication packets to/from the communication apparatus are being performed, and the mode identifying device identifies the operating mode of the communication apparatus as the active mode by a fact that, in a state in which the operating mode of the communication apparatus is identified as the inactive mode, the detecting device has detected a predetermined communication packet indicating that the communication apparatus starts a connection to the communication network, the communication network being a source.

According to the management apparatus of the twenty-first aspect, the mode identifying device identifies the operating mode of the communication apparatus as the active mode by a fact that, in a state in which the operating mode of the communication apparatus is identified as the inactive mode, the detecting device has detected a predetermined communication packet indicating that the communication apparatus starts a connection to the communication network which is the source. Therefore, the fact that the operating mode of the communication apparatus has transitioned from the inactive mode to the active mode can be accurately identified by the mode identifying device.

(3-8) A twenty-second aspect of the present invention provides the management apparatus according to any one of the sixteenth, twentieth, and twenty-first aspects, wherein the plurality of operating modes further include a standby mode in which the power to the communication apparatus is in an on state and sending and receiving of communication packets to/from the communication apparatus are not being performed, and the mode identifying device identifies the operating mode of the communication apparatus as the standby mode by a fact that, in a state in which the operating mode of the communication apparatus is identified as the active mode, the detecting device has not detected a predetermined number or more of communication packets sent and received to/from the communication apparatus, in a last predetermined period.

According to the management apparatus of the twenty-second aspect, the mode identifying device identifies the operating mode of the communication apparatus as the standby mode by a fact that, in a state in which the operating mode of the communication apparatus is identified as the active mode, the detecting device has not detected a predetermined number or more of communication packets sent and received to/from the communication apparatus, in a last predetermined period. Therefore, the fact that the operating mode of the communication apparatus has transitioned from the active mode to the standby mode can be accurately identified by the mode identifying device.

(3-9) A twenty-third aspect of the present invention provides the management apparatus according to any one of the sixteenth, twentieth, and twenty-first aspects, wherein the plurality of operating modes further include a power saving mode in which the power to the communication apparatus is in an on state and some functions of the communication apparatus are not operating, and the mode identifying device identifies the operating mode of the communication apparatus as the power saving mode by a fact that, in a state in which the operating mode of the communication apparatus is identified as the active mode, the power consumption of the communication apparatus obtained by the obtaining device is less than the threshold value and the detecting device has not detected a predetermined communication packet indicating that the communication apparatus leaves the communication network, the communication network being a source.

According to the management apparatus of the twenty-third aspect, the mode identifying device identifies the operating mode of the communication apparatus as the power saving mode by a fact that, in a state in which the operating mode of the communication apparatus is identified as the active mode, the power consumption of the communication apparatus obtained by the obtaining device is less than the threshold value and the detecting device has not detected a predetermined communication packet indicating that the communication apparatus leaves the communication network which is the source. Therefore, the fact that the operating mode of the communication apparatus has transitioned from the active mode to the power saving mode can be accurately identified by the mode identifying device.

(3-10) A twenty-fourth aspect of the present invention provides the management apparatus according to twenty-third aspect, wherein the mode identifying device identifies the operating mode of the communication apparatus as the active mode by a fact that, in a state in which the operating mode of the communication apparatus is identified as the power saving mode, the power consumption of the communication apparatus obtained by the obtaining device is greater than or equal to the threshold value.

According to the management apparatus of the twenty-fourth aspect, the mode identifying device identifies the operating mode of the communication apparatus as the active mode by a fact that, in a state in which the operating mode of the communication apparatus is identified as the power saving mode, the power consumption of the communication apparatus obtained by the obtaining device is greater than or equal to the threshold value. Therefore, the fact that the operating mode of the communication apparatus has transitioned from the power saving mode to the active mode can be accurately identified by the mode identifying device.

(3-11) A twenty-fifth aspect of the present invention provides the management apparatus according to the seventeenth or twenty-second aspect, wherein the plurality of operating modes further include an inactive mode in which the power to the communication apparatus is in a off state, and the mode identifying device identifies the operating mode of the communication apparatus as the inactive mode by a fact that, in a state in which the operating mode of the communication apparatus is identified as the standby mode, the power consumption of the communication apparatus obtained by the obtaining device is less than the threshold value and the detecting device has detected a predetermined communication packet indicating that the communication apparatus leaves the communication network, the communication network being a source.

According to the management apparatus of the twenty-fifth aspect, the mode identifying device identifies the operating mode of the communication apparatus as the inactive mode by a fact that, in a state in which the operating mode of the communication apparatus is identified as the standby mode, the power consumption of the communication apparatus obtained by the obtaining device is less than the threshold value and the detecting device has detected a predetermined communication packet indicating that the communication apparatus leaves the communication network which is the source. Therefore, the fact that the operating mode of the communication apparatus has transitioned from the standby mode to the inactive mode can be accurately identified by the mode identifying device.

(3-12) A twenty-sixth aspect of the present invention provides the management apparatus according to the seventeenth or twenty-second aspect, wherein the plurality of operating modes further include an active mode in which the power to the communication apparatus is in an on state and sending and receiving of communication packets to/from the communication apparatus are being performed, and the mode identifying device identifies the operating mode of the communication apparatus as the active mode by a fact that, in a state in which the operating mode of the communication apparatus is identified as the standby mode, the detecting device has detected a predetermined number or more of communication packets sent and received to/from the communication apparatus, in a last predetermined period.

According to the management apparatus of the twenty-sixth aspect, the mode identifying device identifies the operating mode of the communication apparatus as the active mode by a fact that, in a state in which the operating mode of the communication apparatus is identified as the standby mode, the detecting device has detected a predetermined number or more of communication packets sent and received to/from the communication apparatus, in a last predetermined period. Therefore, the fact that the operating mode of the communication apparatus has transitioned from the standby mode to the active mode can be accurately identified by the mode identifying device.

(3-13) A twenty-seventh aspect of the present invention provides the management apparatus according to the seventeenth or twenty-second aspect, wherein the plurality of operating modes further include a power saving mode in which the power to the communication apparatus is in an on state and some functions of the communication apparatus are not operating, and the mode identifying device identifies the operating mode of the communication apparatus as the power saving mode by a fact that, in a state in which the operating mode of the communication apparatus is identified as the standby mode, the power consumption of the communication apparatus obtained by the obtaining device is less than the threshold value and the detecting device has not detected a predetermined communication packet indicating that the communication apparatus leaves the communication network, the communication network being a source.

According to the management apparatus of the twenty-seventh aspect, the mode identifying device identifies the operating mode of the communication apparatus as the power saving mode by a fact that, in a state in which the operating mode of the communication apparatus is identified as the standby mode, the power consumption of the communication apparatus obtained by the obtaining device is less than the threshold value and the detecting device has not detected a predetermined communication packet indicating that the communication apparatus leaves the communication network which is the source. Therefore, the fact that the operating mode of the communication apparatus has transitioned from the standby mode to the power saving mode can be accurately identified by the mode identifying device.

(3-14) A twenty-eighth aspect of the present invention provides a program causing a computer mounted on a management apparatus that manages a communication apparatus having a plurality of operating modes, to function as: obtaining device for obtaining information about power consumption of the communication apparatus; detecting device for detecting communication packets sent and received to/from the communication apparatus, from a communication network; and mode identifying device for identifying an operating mode of the communication apparatus based on the information about the power consumption obtained by the obtaining device and information about the communication packets detected by the detecting device.

According to the program of the twenty-eighth aspect, the obtaining device obtains information about power consumption of the communication apparatus, and the detecting device detects communication packets sent and received to/from the communication apparatus, from the communication network. Then, the mode identifying device identifies an operating mode of the communication apparatus based on the information about power consumption obtained by the obtaining device and information about the communication packets detected by the detecting device. By the management apparatus thus identifying itself an operating mode of the communication apparatus by the mode identifying device, a notification of the operating mode from the communication apparatus to the management apparatus becomes unnecessary. As a result, it becomes unnecessary to provide the communication apparatus with an operating mode notification function and an increase in the amount of traffic caused by the notification of an operating mode can be avoided.

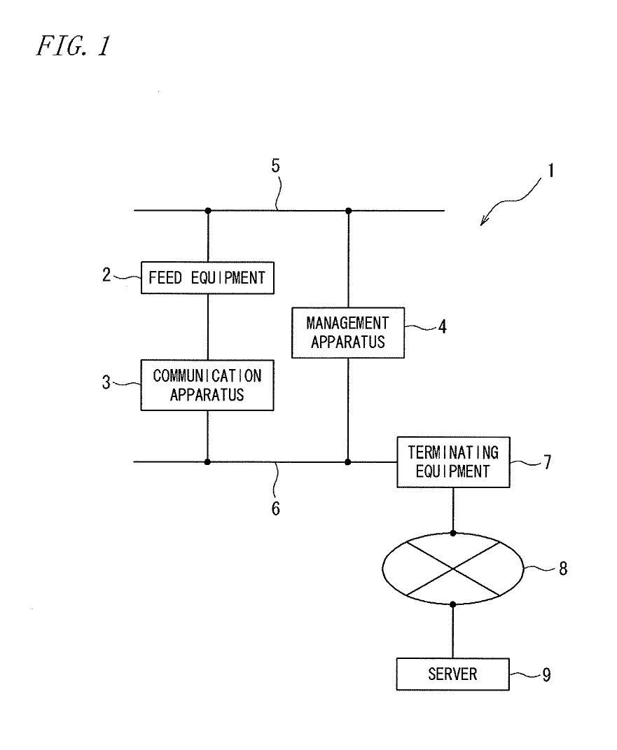

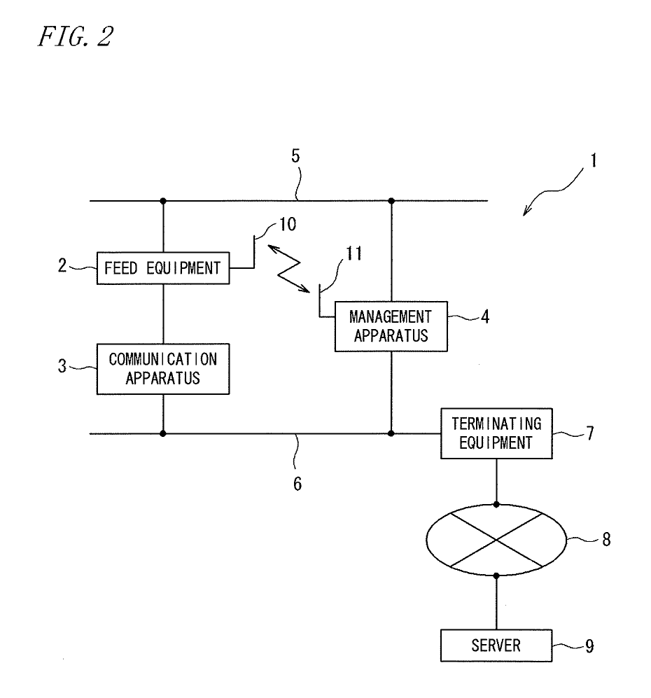

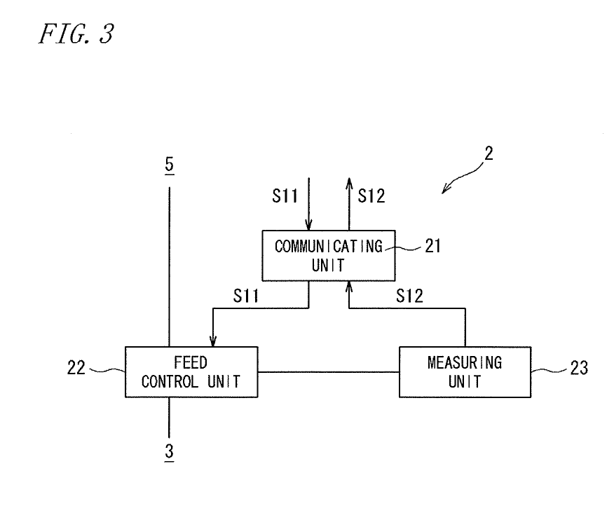

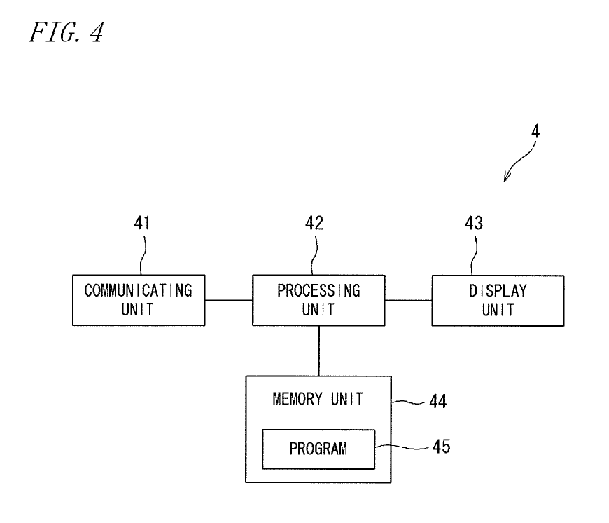

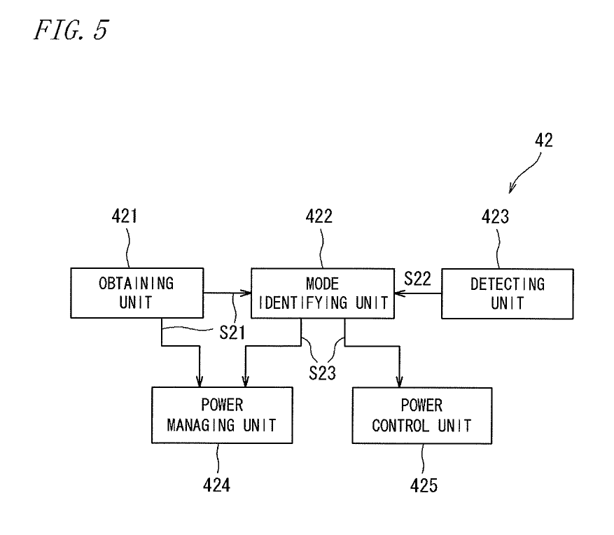

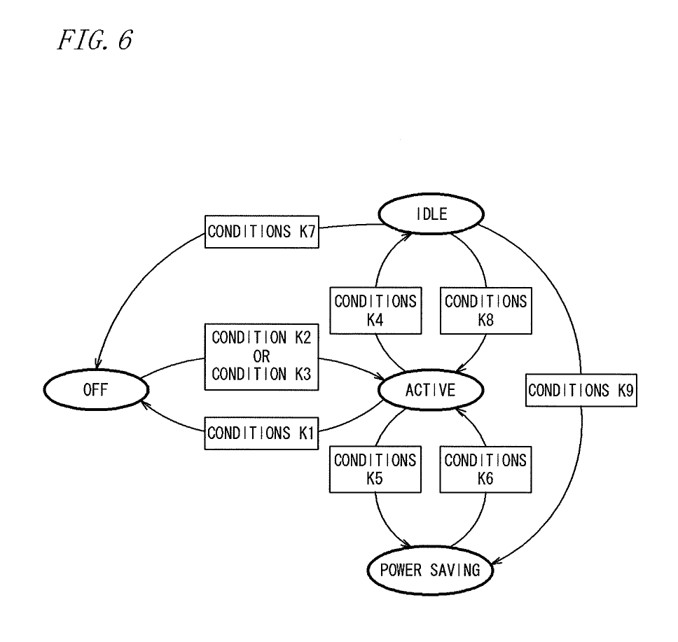

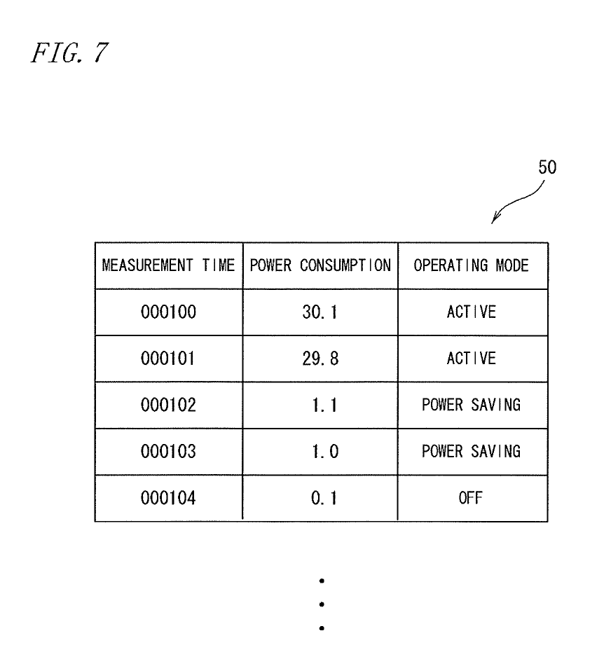

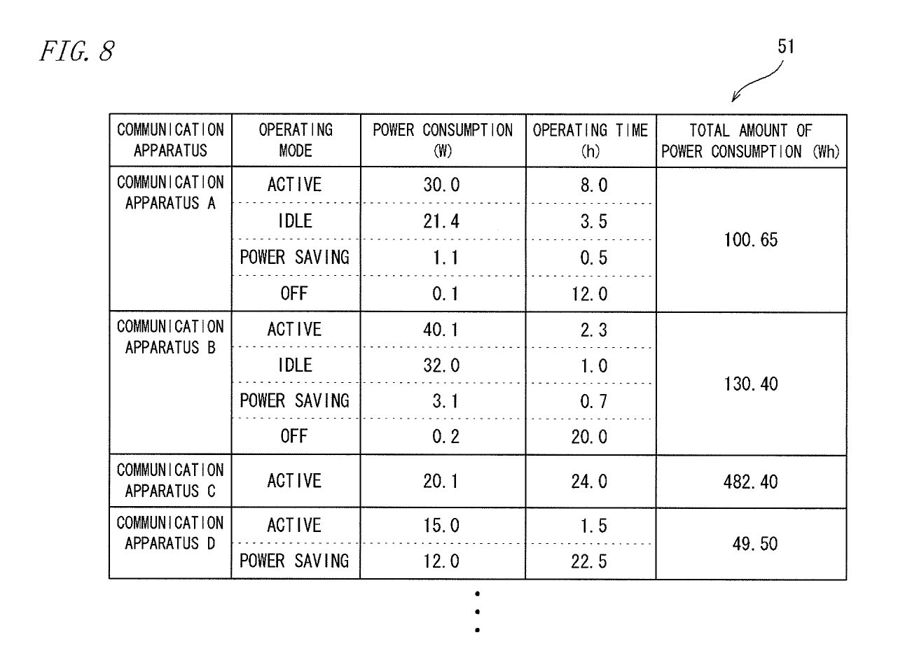

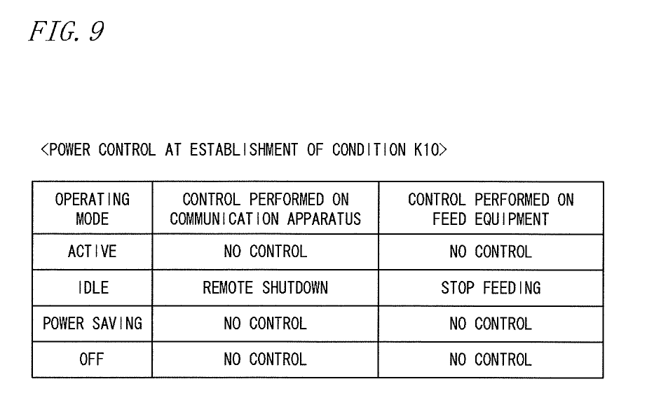

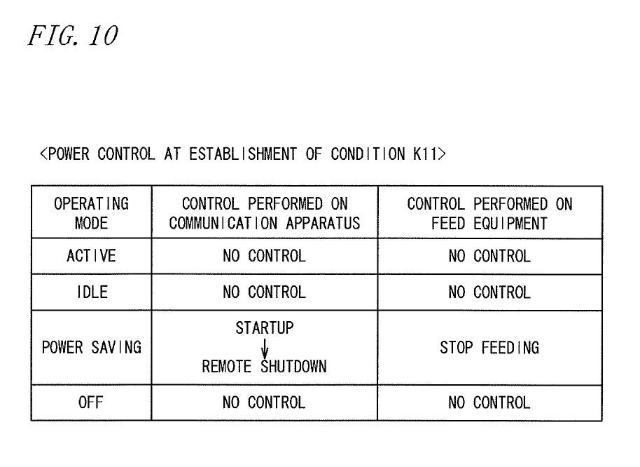

### BRIEF DESCRIPTION OF DRAWINGS

[FIG. 1] FIG. 1 is a diagram showing an overall configuration of a power management system according to an embodiment of the present invention.

[FIG. 2] FIG. 2 is a diagram showing another example of an overall configuration of a power management system according to the embodiment of the present invention.

[FIG. 3] FIG. 3 is a block diagram showing a configuration of a feed equipment.

[FIG. 4] FIG. 4 is a block diagram showing a configuration of a management apparatus.

[FIG. 5] FIG. 5 is a block diagram showing functions that are implemented by a processing unit by executing a program.

[FIG. 6] FIG. 6 is a state transition diagram referred to by a mode identifying unit to identify an operating mode of a communication apparatus.

[FIG. 7] FIG. 7 is a diagram showing an example of management data created by a power managing unit.

[FIG. 8] FIG. 8 is a diagram showing an example of statistical data created by the power managing unit.

[FIG. 9] FIG. 9 is a diagram showing a process performed by a power control unit when a predetermined condition is established.

[FIG. 10] FIG. 10 is a diagram showing a process performed by the power control unit when a predetermined condition is established.

### DESCRIPTION OF EMBODIMENTS

An embodiment of the present invention will be described in detail below using the drawings. Note that those components denoted by the same reference signs in different drawings indicate the same or corresponding components.

FIG. 1 is a diagram showing an overall configuration of a power management system 1 according to an embodiment of the present invention. A feed equipment 2, a communication apparatus 3, a management apparatus 4, and a terminating equipment 7 are arranged indoors such as an office or a user's home. The feed equipment 2 is a power strip or the like that supplies power to the communication apparatus 3. The communication apparatus 3 is any device having a communication function such as a personal computer, a set-top box, a game machine with a communication function, a home server, a home gateway, a hub, or a router. In the following example, the communication apparatus 3 is a personal computer (netbook) whose principal use is to utilize services on the Internet, such as browsing of websites and sending and receiving of emails.

The communication apparatus 3 has a plurality of operating modes. In the following example, the communication apparatus 3 has an active mode in which the power to the communication apparatus 3 is in an on state and the communication apparatus 3 is in a state in which sending and receiving of communication packets to/from the communication apparatus 3 are performed; an idle mode (a standby mode) in which the power to the communication apparatus 3 is in an on state and the communication apparatus 3 is in a state in which sending and receiving of communication packets to/from the communication apparatus 3 are not performed; a power saving mode in which the power to the communication apparatus 3 is in an on state and the communication apparatus 3 is in a state in which some functions of the communication apparatus 3 are not operating (including a state in which the operation is limited); and an off mode (an inactive mode) in which the power to the communication apparatus 3 is in an off state.

The management apparatus 4 is a power management apparatus for performing power management and power control on the communication apparatus 3. The terminating equipment 7 is, for example, an ONU (Optical Network Unit).

The communication apparatus 3, the management apparatus 4, and the terminating equipment 7 are connected to a communication network 6 such as a LAN (Local Area Network). The feed equipment 2 and the management apparatus 4 are connected to a power line 5 and can send and receive signals to/from each other by Power Line Communication (PLC). The communication apparatus 3 is connected to the feed equipment 2, and drive power for allowing the communication apparatus 3 to operate is supplied to the communication apparatus 3 from the power line 5 through the feed equipment 2. Note that although in the example shown in FIG. 1 only one feed equipment 2 is connected to the power line 5, a plurality of feed equipments 2 may be connected. Note also that although only one communication apparatus 3 is connected to the feed equipment 2, a plurality of communication apparatuses 3 may be connected to one feed equipment 2 by providing a plurality of ports on the feed equipment 2.

The terminating equipment 7 is connected to an outdoor communication network 8 such as an IP network. To the communication network 8 is connected a server 9 owned by a contract service company such as a provider.

FIG. 2 is a diagram showing another example of an overall configuration of a power management system 1 according to the embodiment of the present invention. A feed equipment 2 has an antenna 10 and a management apparatus 4 has an antenna 11. The feed equipment 2 and the management apparatus 4 can send and receive signals to/from each other by radio communication using the antennas 10 and 11. Other configurations are the same as those in FIG. 1.

FIG. 3 is a block diagram showing a configuration of the feed equipment 2. As shown in a connection relationship in FIG. 3, the feed equipment 2 is configured to include a communicating unit 21, a feed control unit 22, and a measuring unit 23. The feed control unit 22 selectively controls whether or not to supply drive power from the power line 5, to the communication apparatus 3 (i.e., whether to connect or disconnect a feed path from the power line 5 to the communication apparatus 3), by a signal S11 inputted from the communicating unit 21. The measuring unit 23 measures power consumption of the communication apparatus 3 by periodically measuring power supplied to the communication apparatus 3 from the feed control unit 22, at predetermined time intervals. Then, information about the measured power consumption of the communication apparatus 3 is inputted to the communicating unit 21 as a signal S12. The communicating unit 21 receives a signal S11 for controlling the feed control unit 22 from the management apparatus 4 by power line communication (FIG. 1) or radio communication (FIG. 2). In addition, the communicating unit 21 sends the signal S12 inputted from the measuring unit 23, to the management apparatus 4 by power line communication (FIG. 1) or radio communication (FIG. 2).

FIG. 4 is a block diagram showing a configuration of the management apparatus 4. As shown in a connection relationship in FIG. 4, the management apparatus 4 is configured to include a communicating unit 41, a processing unit 42, a display unit 43, and a memory unit 44. The communicating unit 41 is connected to the communication network 6 shown in FIGS. 1 and 2. In addition, in the example shown in FIG. 1, the communicating unit 41 is connected to the power line 5, and in the example shown in FIG. 2, the communicating unit 41 is connected to the antenna 11. The processing unit 42 is a signal processing device such as a CPU. The display unit 43 is any display device such as a liquid crystal display or an organic EL display. The memory unit 44 is any memory device such as a semiconductor memory or a hard disk. A program 45 for causing the processing unit 42 to operate is stored in the memory unit 44.

FIG. 5 is a block diagram showing functions that are implemented by the processing unit 42 by executing the program 45. The processing unit 42 has an obtaining unit 421, a mode identifying unit 422, a detecting unit 423, a power managing unit 424, and a power control unit 425. In other words, the program 45 is a program for causing a computer mounted on the management apparatus 4 to function as the obtaining unit 421, the mode identifying unit 422, the detecting unit 423, the power managing unit 424, and the power control unit 425.

The obtaining unit 421 obtains information about power consumption of the communication apparatus 3, based on a signal S12 received by the communicating unit 41 from the communication apparatus 3 by power line communication (FIG. 1) or radio communication (FIG. 2). Then, a signal S21 about the information is inputted to the mode identifying unit 422 and the power managing unit 424.

The detecting unit 423 monitors, through the communicating unit 41, all communication packets flowing through the communication network 6 and detects communication packets sent and received to/from the communication apparatus 3 (i.e., communication packets whose source or destination is the communication apparatus 3) from the communication network 6. Then, a signal S22 about the result of the detection is inputted to the mode identifying unit 422. Note that the detecting unit 423 is informed in advance of identification information of the communication apparatus 3 (an IP address, a MAC address, an email address, etc.), and the analyzing unit 423 detects communication packets sent and received to/from the communication apparatus 3, based on the identification information.

The mode identifying unit 422 identifies the current operating mode of the communication apparatus 3 based on the information about the power consumption of the communication apparatus 3 (signal S21) obtained by the obtaining unit 421 and information about the communication packets (signal S22) detected by the detecting unit 423. A technique for identifying an operating mode by the mode identifying unit 422 will be described in detail later. The mode identifying unit 422 inputs information about the identified operating mode of the communication apparatus 3 to the power managing unit 424 and the power control unit 425, as a signal S23.

The power managing unit 424 determines power consumption in each operating mode of the communication apparatus 3 by associating information about power consumption of the communication apparatus 3 obtained by the obtaining unit 421 with operating modes of the communication apparatus 3 identified by the mode identifying unit 422, based on signals S21 inputted from the obtaining unit 421 and signals S23 inputted from the mode identifying unit 422. Examples of use of information indicating power consumption in each operating mode of the communication apparatus 3 which is determined by the power managing unit 424 will be described in detail later.

The power control unit 425 performs power control on the communication apparatus 3 in a manner according to each operating mode, based on the operating mode of the communication apparatus 3 (signal S23) identified by the mode identifying unit 422. Specific examples of power control performed by the power control unit 425 according to each operating mode will be described in detail later.

<Technique for Identifying an Operating Mode by the Mode Identifying Unit>

FIG. 6 is a state transition diagram referred to by the mode identifying unit 422 to identify an operating mode of the communication apparatus 3. The state transition diagram for the communication apparatus 3 is informed in advance to the mode identifying unit 422 and the fact that the communication apparatus 3 is connected to the feed equipment 2 is also informed in advance to the mode identifying unit 422 by user setting, etc. Note that since the operating modes of a communication apparatus and transition conditions between operating modes vary depending on the type of communication apparatus, a state transition diagram according to a communication apparatus which is a management target is created and informed to the management apparatus 4.

The mode identifying unit 422 first identifies any of an active mode, idle mode, and off mode as the operating mode of the communication apparatus 3. Specifically, the mode identifying unit 422 identifies the operating mode of the communication apparatus 3 as the active mode by the fact that the power consumption of the communication apparatus 3 obtained by the obtaining unit 421 is greater than or equal to a predetermined threshold value (e.g., 5 W) and the detecting unit 423 has detected a predetermined number (e.g., 10) or more of communication packets (TCP (Transmission Control Protocol) packets or UDP (User Datagram Protocol) packets) sent and received to/from the communication apparatus 3, in a last predetermined period (e.g., 10 minutes). In this way, the fact that the operating mode of the communication apparatus 3 is the active mode can be accurately identified by the mode identifying unit 422. Note that the numerical values described above are an example and thus are not limited thereto. Appropriate numerical values are set individually according to the type of communication apparatus, the environment of a communication network, or the like (the same applies to the following).

In addition, the mode identifying unit 422 identifies the operating mode of the communication apparatus 3 as an idle mode by the fact that the power consumption of the communication apparatus 3 obtained by the obtaining unit 421 is greater than or equal to the above-described threshold value (e.g., 5 W) and the detecting unit 423 has not detected a predetermined number (e.g., 10) or more of communication packets (TCP packets or UDP packets) sent and received to/from the communication apparatus 3, in a last predetermined period (e.g., 10 minutes). In this way, the fact that the operating mode of the communication apparatus 3 is the idle mode can be accurately identified by the mode identifying unit 422.

In addition, the mode identifying unit 422 identifies the operating mode of the communication apparatus 3 as the off mode when the operating mode does not correspond to either active mode or idle mode due to not satisfying any of the above-described conditions. By this, the operating mode of the communication apparatus 3 can be tentatively identified as the off mode, and the operating mode of the communication apparatus 3 can be accurately identified based on the state transition conditions of the communication apparatus 3 thereafter.

In addition, the mode identifying unit 422 identifies that the operating mode of the communication apparatus 3 has transitioned from the active mode to the off mode, when conditions K1 are satisfied in a state in which the operating mode of the communication apparatus 3 is identified as the active mode. The conditions K1 are that the power consumption of the communication apparatus 3 obtained by the obtaining unit 421 is less than the above-described threshold value (e.g., 5 W) and the detecting unit 423 has detected a predetermined communication packet (an SSDP (Simple Service Discovery Protocol) leave packet or an IGMP (Internet Group Management Protocol) leave packet) indicating that the communication apparatus 3 leaves the communication network 6 which is the source. In this way, the fact that the operating mode of the communication apparatus 3 has transitioned from the active mode to the off mode can be accurately identified by the mode identifying unit 422.

In addition, the mode identifying unit 422 identifies that the operating mode of the communication apparatus 3 has transitioned from the off mode to the active mode, when a condition K2 or a condition K3 is satisfied in a state in which the operating mode of the communication apparatus 3 is identified as the off mode. The condition K2 is that the power consumption of the communication apparatus 3 obtained by the obtaining unit 421 is greater than or equal to the above-described threshold value (e.g., 5 W). The condition K3 is that the detecting unit 423 has detected a predetermined communication packet (an SSDP alive packet or an IGMP alive packet) indicating that the communication apparatus 3 starts a connection to the communication network 6 which is the source. In this way, the fact that the operating mode of the communication apparatus 3 has transitioned from the off mode to the active mode can be accurately identified by the mode identifying unit 422.

In addition, the mode identifying unit 422 identifies that the operating mode of the communication apparatus 3 has transitioned from the active mode to the idle mode, when a condition K4 is satisfied in a state in which the operating mode of the communication apparatus 3 is identified as the active mode. The condition K4 is that the detecting unit 423 has not detected a predetermined number (e.g., 10) or more of communication packets (TCP packets or UDP packets) sent and received to/from the communication apparatus 3, in a last predetermined period (e.g., 10 minutes). In this way, the fact that the operating mode of the communication apparatus 3 has transitioned from the active mode to the idle mode can be accurately identified by the mode identifying unit 422.

In addition, the mode identifying unit 422 identifies that the operating mode of the communication apparatus 3 has transitioned from the active mode to the power saving mode, when conditions K5 are satisfied in a state in which the operating mode of the communication apparatus 3 is identified as the active mode. The conditions K5 are that the power consumption of the communication apparatus 3 obtained by the obtaining unit 421 is less than the above-described threshold value (e.g., 5 W) and the detecting unit 423 has not detected a predetermined communication packet (an SSDP leave packet or an IGMP leave packet) indicating that the communication apparatus 3 leaves the communication network 6 which is the source. In this way, the fact that the operating mode of the communication apparatus 3 has transitioned from the active mode to the power saving mode can be accurately identified by the mode identifying unit 422.

In addition, the mode identifying unit 422 identifies that the operating mode of the communication apparatus 3 has transitioned from the power saving mode to the active mode, when a condition K6 is satisfied in a state in which the operating mode of the communication apparatus 3 is identified as the power saving mode. The condition K6 is that the power consumption of the communication apparatus 3 obtained by the obtaining unit 421 is greater than or equal to the above-described threshold value (e.g., 5 W). In this way, the fact that the operating mode of the communication apparatus 3 has transitioned from the power saving mode to the active mode can be accurately identified by the mode identifying unit 422.

In addition, the mode identifying unit 422 identifies that the operating mode of the communication apparatus 3 has transitioned from an idle mode to an off mode, when conditions K7 are satisfied in a state in which the operating mode of the communication apparatus 3 is identified as an idle mode. The conditions K7 are that the power consumption of the communication apparatus 3 obtained by the obtaining unit 421 is less than the above-described threshold value (e.g., 5 W) and the detecting unit 423 has detected a predetermined communication packet (an SSDP leave packet or an IGMP leave packet) indicating that the communication apparatus 3 leaves the communication network 6 which is the source. In this way, the fact that the operating mode of the communication apparatus 3 has transitioned from the idle mode to the off mode can be accurately identified by the mode identifying unit 422.

In addition, the mode identifying unit 422 identifies that the operating mode of the communication apparatus 3 has transitioned from the idle mode to the active mode, when a condition K8 is satisfied in a state in which the operating mode of the communication apparatus 3 is identified as the idle mode. The condition K8 is that the detecting unit 423 has detected a predetermined number (e.g., 10) or more of communication packets (TCP packets or UDP packets) sent and received to/from the communication apparatus 3, in a last predetermined period (e.g., 10 minutes). In this way, the fact that the operating mode of the communication apparatus 3 has transitioned from the idle mode to the active mode can be accurately identified by the mode identifying unit 422.

In addition, the mode identifying unit 422 identifies that the operating mode of the communication apparatus 3 has transitioned from the idle mode to the power saving mode, when conditions K9 are satisfied in a state in which the operating mode of the communication apparatus 3 is identified as the idle mode. The conditions K9 are that the power consumption of the communication apparatus 3 obtained by the obtaining unit 421 is less than the above-described threshold value (e.g., 5 W) and the detecting unit 423 has not detected a predetermined communication packet (an SSDP leave packet or an IGMP leave packet) indicating that the communication apparatus 3 leaves the communication network 6 which is the source. In this way, the fact that the operating mode of the communication apparatus 3 has transitioned from the idle mode to the power saving mode can be accurately identified by the mode identifying unit 422.

Note that, as described above, upon first identifying any of active mode, idle mode, and off mode as the operating mode of the communication apparatus 3, when the operating mode does not correspond to either active mode or idle mode, the mode identifying unit 422 tentatively identifies the operating mode of the communication apparatus 3 as the off mode. When the operating mode is thus tentatively identified as the off mode, if the threshold value of power consumption for the condition K2 is set to a value greater than the threshold value of power consumption for the condition K6, then as the threshold value of power consumption for the condition K2, the threshold value of power consumption for the condition K6 (i.e., a value smaller than the original value) is used. Thereafter, at the point in time when a transition from the off mode to the active mode is identified, the value of the power consumption for the condition K2 is brought back to the original value. By this, even if the tentative identification of the off mode is wrong and the correct operating mode is the power saving mode, a transition from the power saving mode to the active mode can be identified and thereafter the operating mode of the communication apparatus 3 can be accurately identified.

As such, according to the management apparatus 4 of the present embodiment, the obtaining unit 421 obtains information about the power consumption of the communication apparatus 3, and the detecting unit 423 detects communication packets sent and received to/from the communication apparatus 3 from the communication network 6. Then, the mode identifying unit 422 identifies an operating mode of the communication apparatus 3 based on the information about the power consumption (signal S21) obtained by the obtaining unit 421 and information about the communication packets (signal S22) detected by the detecting unit 423. By the management apparatus 4 thus identifying itself an operating mode of the communication apparatus 3 by the mode identifying unit 422, a notification of the operating mode from the communication apparatus 3 to the management apparatus 4 becomes unnecessary. As a result, it becomes unnecessary to provide the communication apparatus 3 with an operating mode notification function and an increase in the amount of traffic caused by the notification of an operating mode can be avoided.

<Examples of Use of Information Indicating Power Consumption in Each Operating Mode>

As described above, the power managing unit 424 determines power consumption in each operating mode of the communication apparatus 3 by associating information about the power consumption of the communication apparatus 3 (signals S21) obtained by the obtaining unit 421 with operating modes of the communication apparatus 3 (signals S23) identified by the mode identifying unit 422.

FIG. 7 is a diagram showing an example of management data 50 created by the power managing unit 424. A time at which the measuring unit 23 performs measurement of the power consumption of the communication apparatus 3, the value of the power consumption of the communication apparatus 3 measured at that time, and an operating mode of the communication apparatus 3 identified by the mode identifying unit 422 at that time are stored so as to be associated with one another. For example, at the time “000100”, the power consumption is “30.1 W” and the operating mode is “active mode”. In addition, for example, at the time “000103”, the power consumption is “1.0 W” and the operating mode is “power saving mode”. The power managing unit 424 saves the created management data 50 in the memory unit 44 (see FIG. 4). Note that when a plurality of communication apparatuses 3 are managed by the management apparatus 4, the power managing unit 424 creates management data 50 individually for each communication apparatus 3 and saves the management data 50 in the memory unit 44.

FIG. 8 is a diagram showing an example of statistical data 51 created by the power managing unit 424. The power managing unit 424 creates statistical data 51 by performing, based on the management data 50 saved in the memory unit 44, a statistical process on the management data 50 on a predetermined period (one day in the example of FIG. 8) basis. The statistical data 51 describes the type of communication apparatus, the operating mode(s) of each communication apparatus, the average value of power consumption per day in each operating mode of each communication apparatus, the operating time in a day in each operating mode of each communication apparatus, and the total amount of power consumption per day of each communication apparatus such that they are associated with one another. For example, in a communication apparatus A, for an active mode, the power consumption is “30.0 W” and the operating time is “8.0 h”; for an idle mode, the power consumption is “21.4 W” and the operating time is “3.5 h”; for a power saving mode, the power consumption is “1.1 W” and the operating time is “0.5 h”; and for an off mode, the power consumption is “0.1 W” and the operating time is “12.0 h”, and the total amount of power consumption per day is “100.65 Wh”. In addition, for example, in a communication apparatus D, for an active mode, the power consumption is “15.0 W” and the operating time is “1.5 h”; and for a power saving mode, the power consumption is “12.0 W” and the operating time is “22.5 h”, and the total amount of power consumption per day is “49.50 Wh”. The power managing unit 424 saves the created statistical data 51 in the memory unit 44.

With reference to FIG. 4, the management apparatus 4 can output the management data 50 and the statistical data 51 which are saved in the memory unit 44. Specifically, the management data 50 and the statistical data 51 which are saved in the memory unit 44 can be displayed on the display unit 43 serving as output device, and the management data 50 and the statistical data 51 which are saved in the memory unit 44 can be sent to the server 9 (see FIGS. 1 and 2) from the communicating unit 41 serving as output device through the terminating equipment 7 and the communication network 8.

As such, according to the management apparatus 4 of the present embodiment, the obtaining unit 421 obtains information about the power consumption of the communication apparatus 3, and the mode identifying unit 422 identifies an operating mode of the communication apparatus 3. Then, the power managing unit 424 determines power consumption in each operating mode of the communication apparatus 3 by associating information about power consumption (signals S21) obtained by the obtaining unit 421 with operating modes (signals S23) identified by the mode identifying unit 422. By thus determining power consumption in each operating mode of the communication apparatus 3, the power consumption of the communication apparatus 3 having a plurality of operating modes can be accurately determined.

The output device outputs information about the power consumption in each operating mode of the communication apparatus 3 (management data 50 and statistical data 51) which is determined by the power managing unit 424. By outputting the information, the information can be utilized by a user, etc.

The display unit 43 displays information (management data 50 and statistical data 51) about power consumption in each operating mode of the communication apparatus 3. Therefore, the information can be provided to the user, and as a result, the user realizes the power saving effect, enabling to increase user's environmental awareness. In addition, when, for example, buying a new communication apparatus, the user can compare accurate power consumption between communication apparatuses. Thus, by removing a communication apparatus with high power consumption and introducing a new communication apparatus of power saving type, it can help build an environmentally friendly network system.

The communicating unit 41 sends information (management data 50 and statistical data 51) about power consumption in each operating mode of the communication apparatus 3. Therefore, by sending the information to the server 9 of a contract service company such as a provider and accumulating and analyzing the information by the service company, service such as giving advice on a further reduction in power consumption can be provided to the user.

<Specific Examples of Power Control Performed by the Power Control Unit According to Each Operating Mode>

As described above, the power control unit 425 performs power control on the communication apparatus 3 in a manner according to each operating mode, based on an operating mode of the communication apparatus 3 (signal S23) identified by the mode identifying unit 422.

FIG. 9 is a diagram showing a process performed by the power control unit 425 when a predetermined condition K10 is established. The condition K10 is that, in a state in which the operating mode of the communication apparatus 3 is identified as an idle mode, the detecting unit 423 has not detected a predetermined number (e.g., 1) or more of communication packets (TCP packets or UDP packets) sent and received to/from the communication apparatus 3, in a last predetermined period (e.g., 10 minutes). When the operating mode of the communication apparatus 3 at the establishment of the condition K10 is an active mode, a power saving mode, or an off mode, the power control unit 425 does not perform any process. On the other hand, when the operating mode of the communication apparatus 3 at the establishment of the condition K10 is an idle mode, the power control unit 425 sends an instruction to perform a remote shutdown to the communication apparatus 3 from the communication unit 41 through the communication network 6, and sends a signal S11 instructing to stop feeding to the communication apparatus 3 to the feed equipment 2 from the communication unit 41 by power line communication (FIG. 1) or radio communication (FIG. 2). By the communication apparatus 3 receiving the instruction to perform a remote shutdown, the communication apparatus 3 performs a shutdown, by which a reduction in power consumption is achieved. In addition, by the feed equipment 2 receiving the signal S11 instructing to stop feeding to the communication apparatus 3, the feed equipment 2 stops feeding to the communication apparatus 3 from the power line 5, by which a further reduction in power consumption is achieved.

FIG. 10 is a diagram showing a process performed by the power control unit 425 when a predetermined condition K11 is established. The condition K11 is that, in a state in which the operating mode of the communication apparatus 3 is identified as the power saving mode, the power saving mode state continues over a predetermined period of time (e.g., 10 minutes). When the operating mode of the communication apparatus 3 at the establishment of the condition K11 is the active mode, the idle mode, or the off mode, the power control unit 425 does not perform any process. On the other hand, when the operating mode of the communication apparatus 3 at the establishment of the condition K11 is the power saving mode, the power control unit 425 sends a startup instruction (an instruction to resume the operation of functions being stopped due to the power saving mode) and an instruction to perform a remote shutdown to the communication apparatus 3 from the communication unit 41 through the communication network 6, and sends a signal S11 instructing to stop feeding to the communication apparatus 3 to the feed equipment 2 from the communication unit 41 by power line communication (FIG. 1) or radio communication (FIG. 2). By the communication apparatus 3 receiving the startup instruction and thereafter receiving the instruction to perform a remote shutdown, the communication apparatus 3 performs a shutdown, by which a reduction in power consumption is achieved. In addition, by the feed equipment 2 receiving the signal S11 instructing to stop feeding to the communication apparatus 3, the feed equipment 2 stops feeding to the communication apparatus 3 from the power line 5, by which a further reduction in power consumption is achieved.

As such, according to the management apparatus 4 of the present embodiment, the mode identifying unit 422 identifies an operating mode of the communication apparatus 3 and the power control unit 425 performs power control in a manner according to each operating mode identified by the mode identifying unit 422. By the power control unit 425 thus performing power control in a manner according to each operating mode, optimum power control can be performed according to each operating mode while avoiding the occurrence of trouble caused by performing power control that is not suitable for the operating mode.

In addition, as shown in FIG. 9, the power control unit 425 performs power control to shut down the communication apparatus 3 when the condition K10 is satisfied in a state in which the mode identifying unit 422 identifies the operating mode of the communication apparatus 3 as an idle mode. Since power is consumed even in the idle mode, in a situation in which there is a low likelihood of a transition from the idle mode to the active mode, by performing power control to shut down the communication apparatus 3 rather than allowing the idle mode to stay on, the power consumption of the communication apparatus 3 can be reduced over the case in which the idle mode stays on.

In addition, as shown in FIG. 10, the power control unit 425 performs power control to shut down the communication apparatus 3 when the condition K11 is satisfied in a state in which the mode identifying unit 422 identifies the operating mode of the communication apparatus 3 as the power saving mode. Since power is consumed even in the power saving mode, in a situation in which there is a low likelihood of a transition from the power saving mode to the active mode, by performing power control to shut down the communication apparatus 3 rather than allowing the power saving mode to stay on, the power consumption of the communication apparatus 3 can be reduced over the case in which the power saving mode stays on.

In addition to the power control to shut down the communication apparatus 3, the power control unit 425 performs power control to allow the feed equipment 2 to stop feeding to the communication apparatus 3. By stopping feeding to the communication apparatus 3, the power consumption of the communication apparatus 3 can be further reduced.

Note that in the above description the mode identifying unit 422 identifies an operating mode of the communication apparatus 3 based on information about power consumption (signal S21) obtained by the obtaining unit 421 and information about communication packets (signal S22) detected by the detecting unit 423. Instead of this, the mode identifying unit 422 may identify an operating mode of the communication apparatus 3 by obtaining information indicating the current operating mode of the communication apparatus 3 from the communication apparatus 3 by power line communication (FIG. 1) or radio communication (FIG. 2). By the communication apparatus 3 notifying the management apparatus 4 of information indicating its operating mode, the mode identifying unit 422 can accurately identify the operating mode of the communication apparatus 3.

As described above, the management apparatus 4 is configured such that the computer program 45 for causing a computer to function as the management apparatus 4 is installed on the computer. The functions of the management apparatus are exerted by the computer executing the computer program 45. The computer has a processing device, a memory device, and an input-output device, etc., and, for example, a personal computer can be used. Note that the computer program 45 can be stored in a recording medium such as a CD-ROM or a DVD-ROM and sold or handed over. Note also that selling/handing over of the computer program 45 may be performed by downloading the computer program 45 to a computer from a server in which the computer program 45 is stored so as to be downloadable through a network.

Note that the embodiment disclosed herein is to be considered in all respects as illustrative and not restrictive. The scope of the present invention is indicated by the appended claims rather than by the foregoing meanings, and all changes that come within the meanings and range of equivalency of the claims are therefore intended to be embraced therein.

### REFERENCE SIGNS LIST

2: Feed Equipment

3: Communication Apparatus

4: Management Apparatus

5: Power Line

6: Communication Network

9: Server

21: Communicating Unit

22: Feed Control Unit

23: Measuring Unit

41: Communicating Unit

42: Processing Unit

43: Display Unit

44: Memory Unit

45: Program

50: Management Data

51: Statistical Data

421: Obtaining Unit

422: Mode Identifying Unit

423: Detecting Unit

424: Power Managing Unit

425: Power Control Unit

1-15. (canceled)

6. A management apparatus that manages a communication apparatus having a plurality of operating modes, the management apparatus comprising:
mode identifying device for identifying an operating mode of the communication apparatus; and
control device for performing power control of the communication apparatus, wherein
the control device performs power control in a manner according to each operating mode identified by the mode identifying device.

7. The management apparatus according to claim 6, wherein
the plurality of operating modes include a standby mode in which power to the communication apparatus is in an on state and sending and receiving of communication packets to/from the communication apparatus are not being performed, and
the control device performs power control to shut down the communication apparatus when a predetermined condition is satisfied in a state in which the mode identifying device identifies the operating mode of the communication apparatus as the standby mode.

8. The management apparatus according to claim 7, further comprising detecting device for detecting communication packets sent and received to/from the communication apparatus, from a communication network, wherein
the predetermined condition is that, in a state in which the mode identifying device identifies the operating mode of the communication apparatus as the standby mode, the detecting device has not detected a predetermined number or more of communication packets sent and received to/from the communication apparatus, in a last predetermined period.

9. The management apparatus according to claim 6, wherein
the plurality of operating modes include a power saving mode in which power to the communication apparatus is in an on state and some functions of the communication apparatus are not operating, and
the control device performs power control to shut down the communication apparatus when a predetermined condition is satisfied in a state in which the mode identifying device identifies the operating mode of the communication apparatus as the power saving mode.

10. The management apparatus according to claim 9, wherein the predetermined condition is that, in a state in which the mode identifying device identifies the operating mode of the communication apparatus as the power saving mode, the state continues over a predetermined period of time.

11. The management apparatus according to claim 7, wherein the control device further performs power control to stop feeding to the communication apparatus, in addition to the power control to shut down the communication apparatus.

12. The management apparatus according to claim 6, further comprising:
obtaining device for obtaining information about power consumption of the communication apparatus; and
detecting device for detecting communication packets sent and received to/from the communication apparatus, from a communication network, wherein
the mode identifying device identifies the operating mode of the communication apparatus based on the information about the power consumption obtained by the obtaining device and information about the communication packets detected by the detecting device.

13. The management apparatus according to claim 6, wherein the mode identifying device identifies the operating mode of the communication apparatus by obtaining information indicating the operating mode of the communication apparatus from the communication apparatus.

14. A program causing a computer mounted on a management apparatus that manages a communication apparatus having a plurality of operating modes, to function as:
mode identifying device for identifying an operating mode of the communication apparatus; and
control device for performing power control of the communication apparatus, wherein
the control device performs power control in a manner according to each operating mode identified by the mode identifying device.

15. A management apparatus that manages a communication apparatus having a plurality of operating modes, the management apparatus comprising:
obtaining device for obtaining information about power consumption of the communication apparatus;
detecting device for detecting communication packets sent and received to/from the communication apparatus, from a communication network; and
mode identifying device for identifying an operating mode of the communication apparatus based on the information about the power consumption obtained by the obtaining device and information about the communication packets detected by the detecting device.

16. The management apparatus according to claim 15, wherein
the plurality of operating modes include an active mode in which power to the communication apparatus is in an on state and sending and receiving of communication packets to/from the communication apparatus are being performed, and
the mode identifying device identifies the operating mode of the communication apparatus as the active mode by a fact that the power consumption of the communication apparatus obtained by the obtaining device is greater than or equal to a predetermined threshold value and the detecting device has detected a predetermined number or more of communication packets sent and received to/from the communication apparatus, in a last predetermined period.

17. The management apparatus according to claim 15, wherein
the plurality of operating modes include a standby mode in which power to the communication apparatus is in an on state and sending and receiving of communication packets to/from the communication apparatus are not being performed, and
the mode identifying device identifies the operating mode of the communication apparatus as the standby mode by a fact that the power consumption of the communication apparatus obtained by the obtaining device is greater than or equal to a predetermined threshold value and the detecting device has not detected a predetermined number or more of communication packets sent and received to/from the communication apparatus, in a last predetermined period.

18. The management apparatus according to claim 15, wherein
the plurality of operating modes include an inactive mode in which power to the communication apparatus is in a off state, and
the mode identifying device identifies the operating mode of the communication apparatus as the inactive mode when satisfying neither of:
first conditions that the power consumption of the communication apparatus obtained by the obtaining device is greater than or equal to a predetermined threshold value and the detecting device has detected a predetermined number or more of communication packets sent and received to/from the communication apparatus, in a last predetermined period; and
second conditions that the power consumption of the communication apparatus obtained by the obtaining device is greater than or equal to the threshold value and the detecting device has not detected a predetermined number or more of communication packets sent and received to/from the communication apparatus, in a last predetermined period.

19. The management apparatus according to claim 16, wherein
the plurality of operating modes further include an inactive mode in which the power to the communication apparatus is in a off state, and
the mode identifying device identifies the operating mode of the communication apparatus as the inactive mode by a fact that, in a state in which the operating mode of the communication apparatus is identified as the active mode, the power consumption of the communication apparatus obtained by the obtaining device is less than the threshold value and the detecting device has detected a predetermined communication packet indicating that the communication apparatus leaves the communication network, the communication network being a source.

20. The management apparatus according to claim 18, wherein
the plurality of operating modes include an active mode in which the power to the communication apparatus is in an on state and sending and receiving of communication packets to/from the communication apparatus are being performed, and
the mode identifying device identifies the operating mode of the communication apparatus as the active mode by a fact that, in a state in which the operating mode of the communication apparatus is identified as the inactive mode, the power consumption of the communication apparatus obtained by the obtaining device is greater than or equal to the threshold value.

21. The management apparatus according to claim 18, wherein
the plurality of operating modes include an active mode in which the power to the communication apparatus is in an on state and sending and receiving of communication packets to/from the communication apparatus are being performed, and
the mode identifying device identifies the operating mode of the communication apparatus as the active mode by a fact that, in a state in which the operating mode of the communication apparatus is identified as the inactive mode, the detecting device has detected a predetermined communication packet indicating that the communication apparatus starts a connection to the communication network, the communication network being a source.

22. The management apparatus according to claim 16, wherein
the plurality of operating modes further include a standby mode in which the power to the communication apparatus is in an on state and sending and receiving of communication packets to/from the communication apparatus are not being performed, and
the mode identifying device identifies the operating mode of the communication apparatus as the standby mode by a fact that, in a state in which the operating mode of the communication apparatus is identified as the active mode, the detecting device has not detected a predetermined number or more of communication packets sent and received to/from the communication apparatus, in a last predetermined period.

23. The management apparatus according to claim 16, wherein
the plurality of operating modes further include a power saving mode in which the power to the communication apparatus is in an on state and some functions of the communication apparatus are not operating, and
the mode identifying device identifies the operating mode of the communication apparatus as the power saving mode by a fact that, in a state in which the operating mode of the communication apparatus is identified as the active mode, the power consumption of the communication apparatus obtained by the obtaining device is less than the threshold value and the detecting device has not detected a predetermined communication packet indicating that the communication apparatus leaves the communication network, the communication network being a source.

24. The management apparatus according to claim 23, wherein the mode identifying device identifies the operating mode of the communication apparatus as the active mode by a fact that, in a state in which the operating mode of the communication apparatus is identified as the power saving mode, the power consumption of the communication apparatus obtained by the obtaining device is greater than or equal to the threshold value.

25. The management apparatus according to claim 17, wherein
the plurality of operating modes further include an inactive mode in which the power to the communication apparatus is in a off state, and
the mode identifying device identifies the operating mode of the communication apparatus as the inactive mode by a fact that, in a state in which the operating mode of the communication apparatus is identified as the standby mode, the power consumption of the communication apparatus obtained by the obtaining device is less than the threshold value and the detecting device has detected a predetermined communication packet indicating that the communication apparatus leaves the communication network, the communication network being a source.

26. The management apparatus according to claim 17, wherein
the plurality of operating modes further include an active mode in which the power to the communication apparatus is in an on state and sending and receiving of communication packets to/from the communication apparatus are being performed, and
the mode identifying device identifies the operating mode of the communication apparatus as the active mode by a fact that, in a state in which the operating mode of the communication apparatus is identified as the standby mode, the detecting device has detected a predetermined number or more of communication packets sent and received to/from the communication apparatus, in a last predetermined period.

27. The management apparatus according to claim 17, wherein
the plurality of operating modes further include a power saving mode in which the power to the communication apparatus is in an on state and some functions of the communication apparatus are not operating, and
the mode identifying device identifies the operating mode of the communication apparatus as the power saving mode by a fact that, in a state in which the operating mode of the communication apparatus is identified as the standby mode, the power consumption of the communication apparatus obtained by the obtaining device is less than the threshold value and the detecting device has not detected a predetermined communication packet indicating that the communication apparatus leaves the communication network, the communication network being a source.

28. A program causing a computer mounted on a management apparatus that manages a communication apparatus having a plurality of operating modes, to function as:
obtaining device for obtaining information about power consumption of the communication apparatus;
detecting device for detecting communication packets sent and received to/from the communication apparatus, from a communication network; and
mode identifying device for identifying an operating mode of the communication apparatus based on the information about the power consumption obtained by the obtaining device and information about the communication packets detected by the detecting device.

29. The management apparatus according to claim 15, further comprising managing device for determining power consumption in each operating mode of the communication apparatus by associating information about the power consumption obtained by the obtaining device with operating modes identified by the mode identifying device.

30. The management apparatus according to claim 29, further comprising output device for outputting information about the power consumption in each operating mode of the communication apparatus determined by the managing device.
